(19) United States
(12) Patent Application Publication
(10) Pub. No.: US 2013/0002946 A1
(43) Pub. Date: Jan. 3, 2013

(54) VIDEO SIGNAL SENDING APPARATUS, RECEIVING APPARATUS, AND TRANSMISSION METHOD THEREOF

(75) Inventor: HUI-CHIH CHANG, TAIPEI CITY (TW)

(73) Assignee: NUETEQ TECHNOLOGY, INC., TAIPEI CITY (TW)

(21) Appl. No.: 13/244,303

(22) Filed: Sep. 24, 2011

(30) Foreign Application Priority Data
Jun. 29, 2011 (TW) 100122837

(51) Int. Cl. H04N 7/01

(52) U.S. Cl. 348/441; 348/E07.003

(57) ABSTRACT

A video signal sending apparatus includes at least two video adjustment units and a video integration unit. Each video adjustment unit is used for receiving video signals which have more than one original frame rate, and for adjusting each original frame rate into more than one new frame rate. The video integration unit is used for combining each video signal into an integrated video signal which has each original frame rate or each new frame rate, and for transmitting the integrated video signal to a remote end through a sending channel. The sum of the new frame rate of each video signal is smaller than or equals to a maximum frame rate within a bandwidth range of the sending channel. Therefore, the efficiency of video signal transmission may be increased.

### BACKGROUND OF THE INVENTION

1. Field of the Invention

The present invention relates to a signal transmission system; in particular, to a video signal sending apparatus, receiving apparatus, transmission system, and transmission method thereof

2. Description of Related Art

Because of the considerations of usage requirements and operation environments, more and more users provide multiple video sources switching system for achieving several usage requirements when they want to display video signals. Speaking of frameworks of the multiple video sources switching system, they generally include several input terminals, switching circuits, and output terminals. Each input terminal is connected to a video broadcasting device, and each output terminal is connected to a display device, such as a screen or a projector. The video broadcasting devices are selected by switching circuits for providing video sources to the display devices, thus the display devices may display the video contents wished to be seen.

When the user wants to transmit several sets of video signals to a remote end, he or she usually uses the Internet as network medium. However, because the volumes of the video signals are relatively large, thus, if the video signals are transmitted by the Internet without being compressed, there must have a transmission jam among the Internet having limited bandwidth. Therefore, for transmitting video signals through the internet with limited bandwidth, lossless data compression and distortion data compression are provided. The mentioned compression manners compress the video signals at the sending end before transmission starts, for reducing the occupied bandwidth of the video signal during transmission. Then the receiving end may use the corresponding decompression manners for recovering the video signals.

Under the situation of lossless data compression, although the video signals are undistorted, each video signal needs relatively large bandwidth. Thus, because of the restriction of transmission bandwidth, the amount of transmitted video signals may also be limited. Under the situation of the distortion data compression, although the requisite transmission bandwidth is relatively small and the amount of transmitted video signals may be increased, the video signals are distorted after they are decompressed.

Therefore, the mentioned conventional compression transmission manners may have some bothering problems, and designs of a video signal transmission system may be an important issue among researchers.

### SUMMARY OF THE INVENTION

A video signal sending apparatus, a video signal receiving apparatus, and a video signal transmission method thereof are disclosed, which adjust frame rates of video signals during video signal transmission, for reducing data volumes of the video signals and increasing the amount of transmitted video signals without changing transmission lines. If the network transmission lines are used, the speed and the efficiency of video signal transmission may even be improved.

According to an embodiment of the present invention, a video signal sending apparatus is disclosed. The video signal sending apparatus is connected with at least two video devices, and includes at least two video adjustment units and a video integration unit. Each video adjustment unit is used for receiving the video signals which are transmitted by each video device and have more than one original frame rate, and for adjusting the original frame rate of each video signal into more than one new frame rate. The video integration unit is used for combining the video signals into an integrated video signal having each original frame rate or each new frame rate and for transmitting the integrated video signal to a remote end through a sending channel. The sum of the new frame rates of each video signal is smaller than or equals to a maximum frame rate within a bandwidth range of the sending channel.

According to the present invention, a video signal receiving apparatus is disclosed. The video signal receiving apparatus is connected with at least one display device, and includes a video separation unit and at least one video adjustment unit. The video separation unit is used for receiving an integrated video signal having more than one original frame rate, and for separating the integrated video signal into at least two video signals having more than one new frame rate. Each video adjustment unit is used for receiving the video signals having each new frame rate and outputted by the video separation unit, and for increasing or reducing each new frame rate of each video signal and transmitting the video signals to each display device.

According to the present invention, a video signal transmission method is disclosed. The method is applicable to at least two video signal sending apparatuses and at least one video signal receiving apparatus. Each video signal sending apparatus adjusts more than one original frame rate of each received video signal into more than one new frame rate. Each video signal receiving apparatus combines each video signal having each new frame rate into an integrated video signal having each original frame rate. Each video signal sending apparatus sends the integrated video signal to a remote end.

On the basis of the above, the video signal transmission operations may be executed without increasing transmission bandwidth. The embodiments of the present invention show that a frame rate adjustment and a combination of video signals may be implemented at sending end, for reducing data volume of each video signal which is going to be transmitted. Then the video signal transmission is executed, and the receiving end may recover the frame rate of each video signal and output the video signal to a display device. Therefore, the efficiency of video signal transmission and the utilization rate of the transmission bandwidth may be improved. In addition, the data missing problems during transmission may be avoided, which improves transmission quality.

For further understanding of the present disclosure, reference is made to the following detailed description illustrating the embodiments and examples of the present disclosure. The description is only for illustrating the present disclosure, not for limiting the scope of the claim.

### BRIEF DESCRIPTION OF THE DRAWINGS

FIG. 1A shows a schematic diagram of video signal transmission according to the present invention;

FIG. 1B shows another schematic diagram of video signal transmission according to the present invention;

FIG. 2 shows a system block diagram of a video signal sending apparatus according to the present invention;

FIG. 3 shows a system block diagram of a video signal receiving apparatus according to the present invention;

FIG. 4 shows a system block diagram of a video signal transmission system according to the present invention; and

FIG. 5 shows a flow chart according to the present invention.

### DETAILED DESCRIPTION OF THE PREFERRED EMBODIMENTS

[Embodiments of Video Transmission]

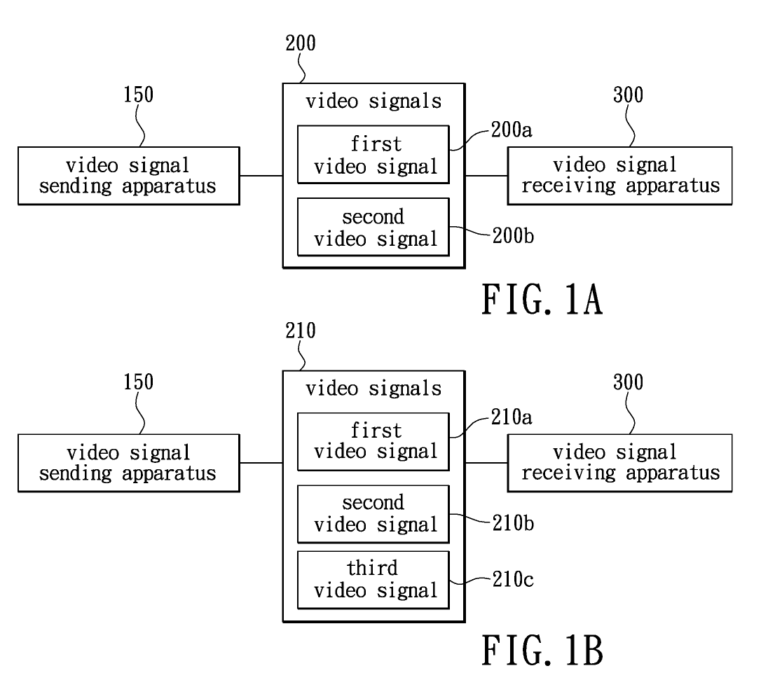

Please refer to FIG. 1A. FIG. 1A is a schematic diagram of video signal transmission according to the present invention. The video signal transmission system in FIG. 1A includes a video signal sending apparatus 150 and a video signal receiving apparatus 300. A sending channel between the video signal sending apparatus 150 and the video signal receiving apparatus 300 transmits two video signals. The sending channel may be implemented by an original transmission line, a CAT 5 twisted pair cable, an optical fiber, a data bus, or other kinds of network transmission mediums. In addition, the number of transmitted video signal may be at least two, and the data volumes, frame rates, or formats of each set of the video signal may be different from one another.

An adjustment process may be executed by the video signal sending apparatus 150, for adjusting an original frame rate of the video signal received. A demodulation process may be executed by the video signal receiving apparatus 300, for receiving and recovering the frame rate of the video signal being sent by the video signal sending apparatus 150. The mentioned frame rate may refer to a screen refresh rate which is a measurement for measuring display frame rate. The unit of measurement of the frame rate may be frame per second (FPS) or hertz (Hz).

The video signals 200 includes a first video signal 200a having a first frame rate and a second video signal 200b having a second frame rate. A sum of the first frame rate and the second frame rate may be a maximum frame rate within a bandwidth range of the sending channel, or may be the original frame rate, wherein the first frame rate and the second frame rate may be smaller than the original frame rate. In addition, according to other design considerations, the sum of the first frame rate and the second frame rate may also be smaller than the original frame rate.

For example, when the video signal sending apparatus 150 receives the first video signal 200a and the second video signal 200b which both have original frame rates equaling to 60 Hz, the first video signal 200a having the first original frame rate equaling to 60 Hz may be adjusted into the first video signal 200a having the first frame rate equaling to 30 Hz by the adjustment process of the video signal sending apparatus 150. Similarly, the second video signal 200b having the second original frame rate equaling to 60 Hz may also be adjusted into the second video signal 200b which has the second frame rate equaling to 30 Hz by the adjustment process of the video signal sending apparatus 150. Under this situation, the sum of the first frame rate (equaling to 30 Hz) and the second frame rate (equaling to 30 Hz) may equals to the maximum frame rate within the bandwidth range of the sending channel, or may equals to the first or second original frame rate (equaling to 60 Hz). In addition, the first original frame rate and the second original frame rate may be the same or be different from each other.

After that, when the video signal receiving apparatus 300 receives the first video signal 200a having the first frame rate equaling to 30 Hz and the second video signal 200b having the second frame rate equaling to 30 Hz, the first video signal 200a having the first frame rate equaling to 30 Hz may be adjusted back to the first video signal 200a having the first original frame rate equaling to 60 Hz by the demodulation process of the video signal receiving apparatus 300. Similarly, the second video signal 200b having the second frame rate equaling to 30 Hz may also be adjusted back to the second video signal 200b having the second original frame rate equaling to 60 Hz.

Because the frame rate is in direct proportion to data volume, low frame rate may represent low data volume. In other words, according to the present invention, the transmission of several video signals under limited bandwidth may be implemented by adjusting the frame rates of the video signals. In addition, because the manner used in this embodiment has no association to data compression, thus the quality of the video signal may be maintained and not be influenced.

Please refer to FIG. 1B. FIG. 1B is another schematic diagram of video signal transmission according to the present invention. The video signal transmission system in FIG. 1B includes a video signal sending apparatus 150 and a video signal receiving apparatus 300. The sending channel between the video signal sending apparatus 150 and the video signal receiving apparatus 300 transmits three video signals. The operation of the adjustment process and the demodulation process of the video signal sending apparatus 150 and the video signal receiving apparatus 300 respectively are described above, thus the following disclosure may not go into details again. The amount of the transmitted video signals may be more than three.

The video signal 210 includes a first video signal 210a having a first frame rate, a second video signal 210b having a second frame rate, and a third video signal 210c which having a third frame rate. The sum of the first frame rate, the second frame rate, and the third frame rate may be the maximum frame rate within the bandwidth of the sending channel, or may be the original frame rate before being adjusted by the video signal sending apparatus 150. For example, when the original frame rate equals to 60 Hz, the first frame rate, the second frame rate, and the third frame rate may be respectively configured to 20 Hz, 20 Hz, 20 Hz; or 40 Hz, 10 Hz, 10 Hz; or 30 Hz, 20 Hz, 10 Hz; or 10 Hz, 40 Hz, 10 Hz, and so on.

Therefore, the values of the adjusted frame rates may be designed according to the amount of the video signals transmitted. That is, the rule of adjustment may divide the original frame rate by the number of the video signals transmitted for acquiring the adjusted frame rates. Alternatively, the value of the original frame rate may be subtract by a specific value, such as any integer value which is smaller than the original frame rate, for acquiring the adjusted frame rates. Optimally, the adjusted frame rate may be an integer, and the sum of each adjusted frame rate may equal to the maximum frame rate within the bandwidth of the sending channel or the original frame rate. The mentioned rules of the adjustment process are only for references, not for limiting the scope of the present invention.

[Embodiment of Video Signal Sending Apparatus]

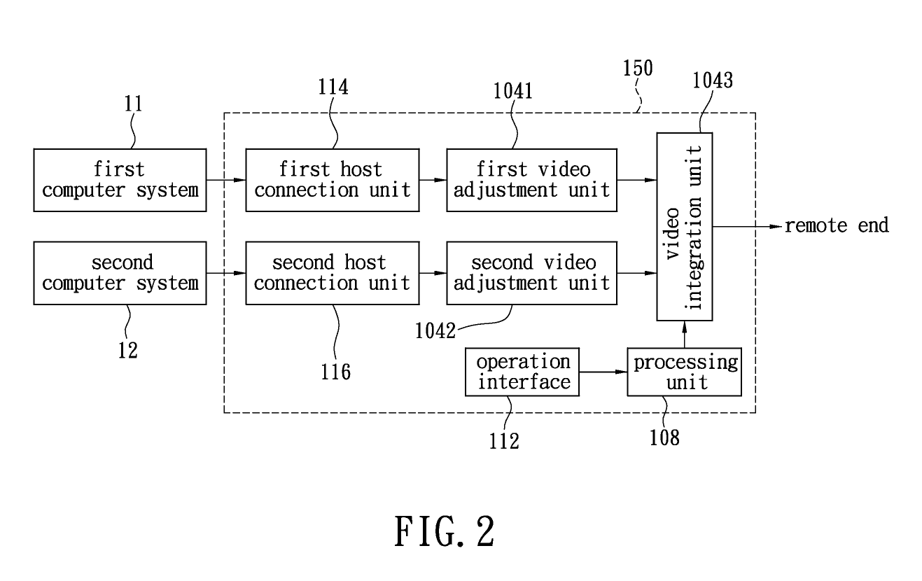

Please refer to FIG. 2. FIG. 2 is a system block diagram of a video signal sending apparatus according to the present invention. The video signal sending apparatus 150 includes a first host connection unit 114, a second host connection unit 116, a first video adjustment unit 1041, a second video adjustment unit 1042, a video integration unit 1043, a processing unit 108, and an operation interface 112.

The video signal sending apparatus 150 is connected to a first computer system 11 through the first host connection unit 114, for receiving a first video signal having a first original frame rate from the first computer system 11. Similarly, the video signal sending apparatus 150 is also connected to a second computer system 12 through the second host connection unit 116, for receiving a second video signal having a second original frame rate from the second computer system 12. The first host connection unit 114 and the second host connection unit 116 may be digital visual interface (DVI) modules, high definition multimedia interface (HDMI) modules, digital display ports (DP), video graphics arrays (VGA), or other kinds of video interface modules. The first host connection unit 114 and the second host connection unit 116 may be the same or different interface standards.

The first computer system 11 and the second computer system 12 may be cameras, desktop computers, tablet computers, servers, notebook computers, video displayers (such as blue-ray, DVD, or VCD player), or other kinds of devices which are compatible with high-bandwidth digital content protection (HDCP) standards. The video signal sending apparatus 150 may be set in the first computer system 11 and the second computer system 12 (or other kinds of video devices), a switch, a splitter, a matrix, and an extender. Because the switch, the splitter, the matrix, and the extender are well known signal processing devices, the following disclosure may not go into details. The first original frame rate and the second original frame rate may be the same or be different from each other.

The first video adjustment unit 1041 is connected with the first host connection unit 114. The first video adjustment unit 1041 is used for receiving the first video signal having the first original frame rate, and for adjusting the first original frame rate into a first frame rate. The first video adjustment unit 1041 may be a digital signal processing (DSP) chip or a field programmable gate array (FPGA), for scaling video signals or converting video formats.

The second video adjustment unit 1042 is connected with the second host connection unit 116. The second video adjustment unit 1042 is used for receiving the second video signal having the second original frame rate, and for adjusting the second original frame rate into a second frame rate. The second video adjustment unit 1042 may be a DSP chip or an FPGA, for scaling video signals or converting video formats.

The video integration unit 1043 is connected with the first video adjustment unit 1041 and the second video adjustment unit 1042. The video integration unit 1043 is used for combining the first video signal outputted by the first video adjustment unit 1041 and the second video signal outputted by the second video adjustment unit 1042 into an integrated video signal having the first or the second original frame rate. The frame rate of the integrated video signal may be set as the first original frame rate or the second original frame rate according to user selections or other computing algorisms. The video integration unit 1043 sends the integrated video signal to a remote end or a next circuit, wherein there may have a transmission connection unit (not shown) between the video integration unit 1043 and the remote end, for converting the transmission format of the integrated video signal into the transmission format which can be used in the sending channel. The transmission connection unit may be omitted if the transmission format conversion is not necessary.

The processing unit 108 is connected with the video integration unit 1043. The processing unit 108 is used for controlling the video integration unit 1043 to execute the processes of video signal integration. The processing unit 108 may be a central processing unit (CPU), a micro controller, an embedded controller, or a digital logic circuit.

The operation interface 112 is connected with the processing unit 108. The operation unit 112 may be at least one button or key, an on screen display (OSD) interface, an OSB interface, or an infrared (IR) communication interface. The operation interface 112 may generate operation commands according to user operations, and may send the operation commands to the processing unit 108 for configuring the output frame rates of the first video adjustment unit 1041 and the second video adjustment unit 1042 according to the operation commands. In addition, in another embodiment of the present invention, if the output frame rates of the first video adjustment unit 1041 and the second video adjustment unit 1042 are fixed, the operation interface 112 may be omitted.

[Embodiments of Video Signal Receiving Apparatus]

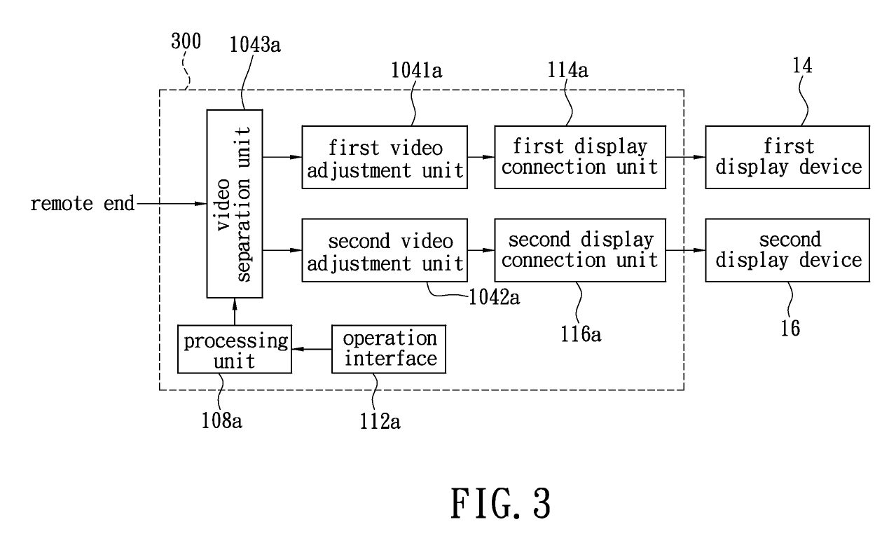

Please refer to FIG. 3. FIG. 3 is a system block diagram of a video signal receiving apparatus according to the present invention. Some elements of the video signal receiving apparatus 300 are the same as their counterparts in the video signal sending apparatus 150, thus the following disclosure may not go into details again. The video signal receiving apparatus 300 includes a first video adjustment unit 1041a, a second video adjustment unit 1042a, a video separation unit 1043a, a processing unit 108a, an operation interface 112a, a first display connection unit 114a, and a second display connection unit 116a.

The video separation unit 1043a receives an integration video signal having a first or second original frame rate from a remote end. The remote end may be a previous circuit. There may have a transmission connection unit (not shown) connected between the video separation unit 1043a and the remote end, for converting transmission format of the integrated video signal into the transmission format which may be applicable to the video separation unit 1043a. If the conversion operation is not necessary, the transmission connection unit may be omitted. The video separation unit 1043a is used for separating the integrated video signal into a first video signal having a first frame rate and a second video signal having a second frame rate.

The first video adjustment unit 1041a is connected to the video separation unit 1043a. The first video adjustment unit 1041a receives the first video signal having the first frame rate. The framework and utility of the first video adjustment unit 1041a may be the same as the first video adjustment unit 1041. Specifically, the first video adjustment unit 1041a may have the capabilities of scaling the first video signal and converting the video format of the first video signal. The first video adjustment unit 1041a may be used for adjusting the first frame rate into a first original frame rate. In addition, the first video adjustment unit 1041a may also increase or reduce the value of the first frame rate of the first video signal into other frame rate value for matching the usage requirements of the first display device 14, or may convert the video format of the first video signal.

The second video adjustment unit 1042a is connected to the video separation unit 1043a. The second video adjustment unit 1042a receives the second video signal having the second frame rate. The framework and utility of the second video adjustment unit 1042a may be the same as the second video adjustment unit 1042. Specifically, the second video adjustment unit 1042a may have the capabilities of scaling the second video signal and converting the video format of the second video signal. The second video adjustment unit 1042a may be used for adjusting the second frame rate into a second original frame rate. In addition, the second video adjustment unit 1042a may also increase or reduce the value of the second frame rate of the second video signal into other frame rate value for matching the usage requirements of the first display device 14 and the second display device 16, or may convert the video format of the second video signal.

The processing unit 108a is connected with the video separation unit 1043a. The processing unit 108a may be used for controlling the video separation unit 1043a for executing the video signal separation process. The operation interface 112a is connected with the processing unit 108a. The operation interface 112a is used for generating operation commands according to user operations, and for transmitting the operation commands to the processing unit 108a. After that, the processing unit 108a may configure the output frame rates of the first video adjustment unit 1041a and the second video adjustment unit 1042a according to the operation commands. The first video adjustment unit 1041a and the second video adjustment unit may output the corresponding video signals at the same time, or output the corresponding video signals by turns, or selectively output the same video signal at the same time. In addition, in another embodiment of the present invention, if the output frame rates of the first video adjustment unit 1041a and the second video adjustment unit 1042a are fixed, the operation interface 112a may be omitted.

The first display connection unit 114a is connected to the first video adjustment unit 1041a. The second display connection unit 116a is connected to the second video adjustment unit 1042a. The first display connection unit 114a and the second display connection unit 116a may be DVI modules, HDMI modules, digital DPs, VGAs, or other kinds of video interface modules. The first display connection unit 114a and the second display connection unit 116a may be the same interface or be different from each other. In addition, the first display connection unit 114a and the second display connection unit 116a may also be connection sockets corresponding to the interface modules, which connect to the first display device 14 and the second display device 16 by connecting with connection plugs with the same interface.

The video signal receiving apparatus 300 is connected to the first display device 14 through the first display connection unit 114a, for transmitting the first video signal to the first display device 14 and for displaying the first video signal. The video signal receiving apparatus 300 is also connected to the second display device 16 through the second display connection unit 116a, for transmitting the second video signal to the second display device 16 and for displaying the second video signal. The first display device 14 and the second display device 16 may be televisions, projectors, cathode ray tube (CRT) screens, liquid crystal display (LCD) screens, or other video outputting devices. The video signal receiving apparatus 300 may set in a switch, a splitter, a matrix, an extender, the first display device 14, the second display device 16, or other display devices. In addition, in one embodiment of the present invention, a set of video adjustment unit, a set of display connection unit, and a set of display device may be used according to usage requirements.

It is worth noting that the video signal receiving apparatus 300 may control the first display device 14 and the second display device 16 for displaying the same screen or different screens at the same time.

[Embodiments of Video Signal Transmission System]

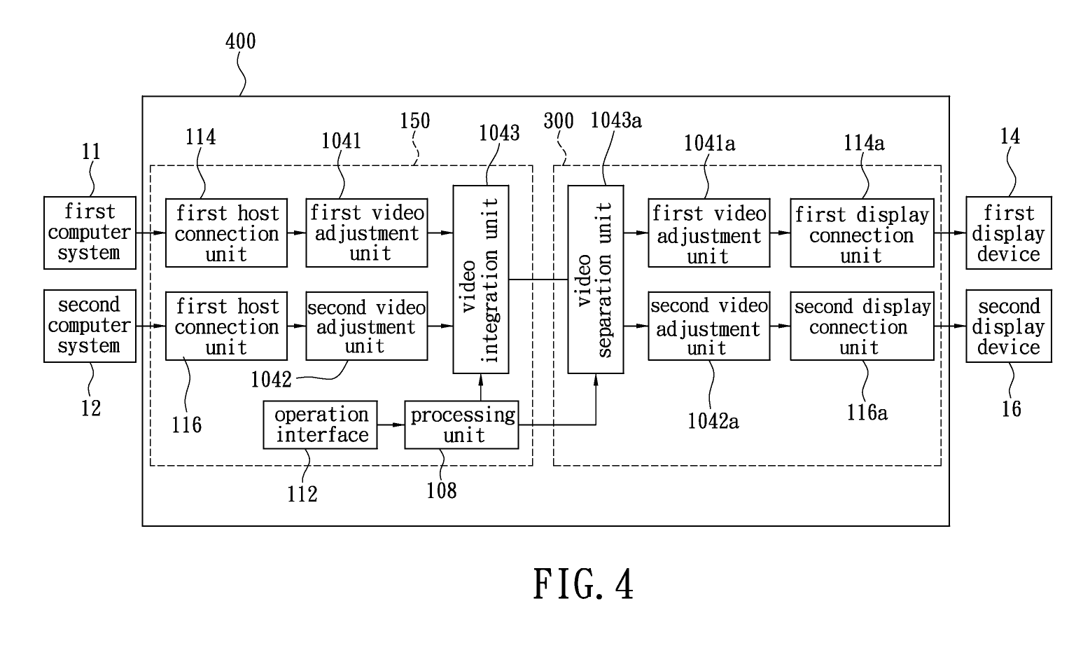

Please refer to FIG. 4. FIG. 4 is a system block diagram of a video signal transmission system according to the present invention. The video signal transmission system 400 in FIG. 4 is connected with two computer systems (including a first computer system 11 and a second computer system 12) and two display devices (including a first display device 14 and a second display device 16). The video signal transmission system 400 includes a video signal sending apparatus 150 and a video signal receiving apparatus 300. The video signal sending apparatus 150 and the video signal receiving apparatus 300 may be integrated in a circuit carrier board or a set top box. Because the operation of the video signal sending apparatus 150 and the video signal receiving apparatus 300 are respectively described in FIG. 2 and FIG. 3 already, the following disclosure may not go into details again. Generally, the number of the video signal sending apparatus 150 equals to the number of the video adjustment unit of the video signal receiving apparatus 300. However, the number of the video adjustment unit of the video signal receiving apparatus 300 may be increased or reduced according to other design considerations.

The video integration unit 1043 and the video separation unit 1043a may be connected with each other through a sending channel or a bus. The processing unit 108 is connected to both the video integration unit 1043 and the video separation unit 1043a. The processing unit 108 may control the video integration unit 1043 for executing the video signal integration processes, and may control the video separation unit 1043a for executing the video signal separation processes.

The operation interface 112 may be used for generating operation commands according to user operations, and for transmitting the operation commands to the processing unit 108. After that, the processing unit 108 may configure the values of the output frame rates of the first video adjustment unit 1041, the second video adjustment unit 1042, the first video adjustment unit 1041a, and the second video adjustment unit 1042a. It is worth noting that the numbers of the computer systems and the display devices which are connected with the video signal transmission system 400 are only for references, but not for restricting the scope of the present disclosure. If the number of the computer systems which are connected to the video signal transmission system 400 is more than two, the numbers of the host connection unit and the video adjustment unit may be increased correspondingly. Moreover, if the number of the display device is one or more than one, the numbers of the video adjustment unit and the display connection unit may also be changes correspondingly.

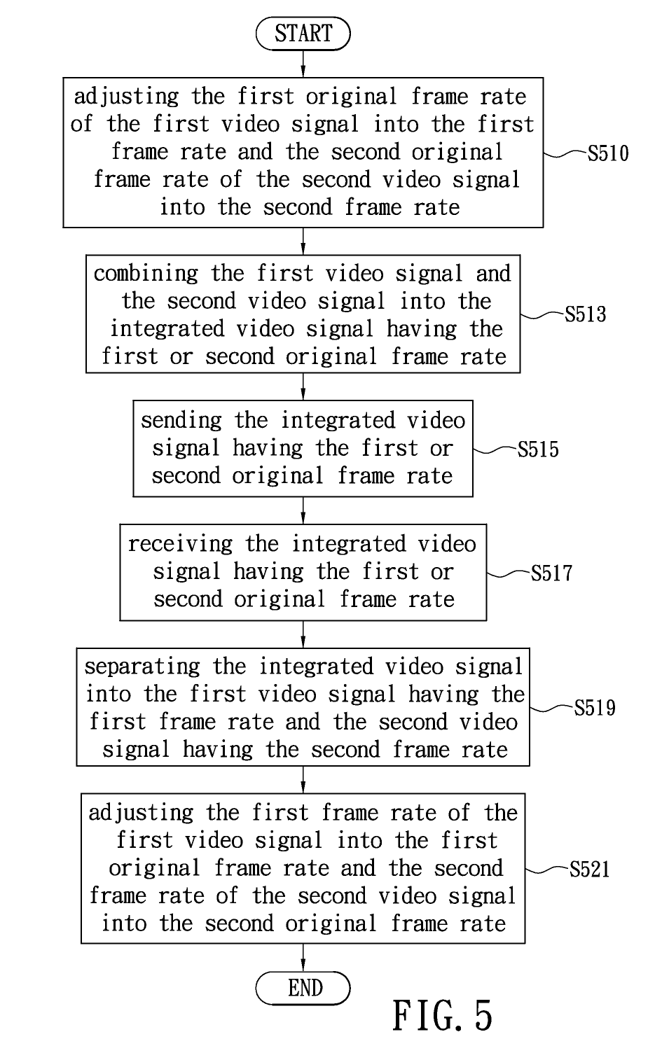

Please refer to FIG. 4 and FIG. 5. FIG. 5 is a flow chart of a video signal transmission method according to the present invention. The method includes a step S510 of receiving a first video signal which has a first original frame rate and a second video signal which has a second original frame rate by the video signal sending apparatus 150, and adjusting the first original frame rate of the first video signal into a first frame rate and the second original frame rate of the second video signal into a second frame rate by the video signal sending apparatus 150. The first frame rate and the second frame rate may be smaller than the first original frame rate and the second original frame rate respectively, for reducing the corresponding data volumes of the first video signal and the second video signal. The user may set the first frame rate and the second frame rate of the video signal sending apparatus 150 by using the operation interface 112. The first frame rate and the second frame rate may be the same or be different from each other.

In step S513, the video signal sending apparatus 150 combines the first video signal and the second video signal into an integrated video signal having the first or second original frame rate. It is worth noting that the sum of the first frame rate and the second frame rate may be smaller than or equals to a maximum frame rate within the bandwidth of the sending channel, or may be the first or second original frame rate. In step S515, the video signal sending apparatus 150 may output the integrated video signal with the maximum frame rate, the first original frame rate, or the second original frame rate to a remote end (or to a next circuit) through the sending channel. In step S517, the video signal receiving apparatus 300 may receive the integrated video signal from a remote end (or from a previous circuit) through the sending channel.

In step S519, the video signal receiving apparatus 300 separates the integrated video signal into the first video signal having the first frame rate and the second video signal having the second frame rate. In step S521, the video signal receiving apparatus 300 adjusts the first frame rate of the first video signal back to the first original frame rate and the second frame rate back to the second original frame rate. In another embodiment of the present invention, the video signal receiving apparatus 300 may increase or reduce the first frame rate of the first video signal into any other value, and may output the first video signal to the first display device 14. In addition, the video signal receiving apparatus may have an operation of converting video formats, for outputting the video signal to the first display device 14 or the second display device 16 which have different video interfaces. The first display device 14 and the second display device 16 may have the same video interface or different video interfaces according to actual requirements.

Similarly, in another embodiment of the present invention, the video signal receiving apparatus 300 may increase or reduce the second frame rate of the second video signal into any other value, and may output the second video signal to the second display device 16. In addition, the video signal receiving apparatus 300 may control the first display device 14 and the second display device 16 to display the same screen or the different screens. The user may use the operation interface 112 for setting the first frame rate and the second frame rate of the video signal receiving apparatus 300. In this embodiment, there are two transmitted video signals, but the description is not for limiting the scope of the present invention. That is, the number of the transmitted video signals may be more than two, and the data volumes, the frame rates, and the formats of the video signals may be different from one another.

On the basis of the above, the video signal transmission of the present invention may be executed under original transmission bandwidth. The embodiments of the present invention may adjust the frame rates of the video signals and combining the video signals at sending end, for reducing the data volumes of the video signals during data transmission. After that, the video signal transmission operation may be executed. The receiving end may recover the frame rates of the video signals for outputting the video signals to the display devices. Therefore, the efficiency of video signal transmission and the utilization rate of the transmission bandwidth may be increased. In addition, the problem of data missing during video signal transmission may be improved.

The aforementioned disclosures are only for references, not for limiting the scope of the present invention.

What is claimed is:

1. A video signal sending apparatus which is connected with at least two video devices, comprising:
at least two video adjustment units, wherein each video adjustment unit is used for receiving video signals which have more than one original frame rate and are outputted by each video device, and for adjusting each original frame rate of each video signal into more than one new frame rate; and
a video integration unit for combining each video signal into an integrated video signal which has each original frame rate or each new frame rate, and for sending the integrated video signal to a remote end through a sending channel;
wherein a sum of each new frame rate of each video signal is smaller than or equals to a maximum frame rate within a bandwidth range of the sending channel.

2. The video signal sending apparatus according to claim 1, wherein the video signal sending apparatus is respectively set in each video device, a switch, a splitter, a matrix, or an extender.

3. The video signal sending apparatus according to claim 1, wherein each video device is a camera, a desktop computer, a server, a notebook computer, or a video display.

4. The video signal sending apparatus according to claim 1, wherein a data capacity, each frame rate, or a format of each video signal are different from one another.

5. The video signal sending apparatus according to claim 1, wherein each video device has different video interfaces.

6. A video signal receiving apparatus which is connected with at least one display device, comprising:
a video separation unit for receiving an integrated video signal having more than one original frame rate, and for separating the integrated video signal into at least one video signal which has more than one new frame rate; and
at least one video adjustment unit, wherein each video adjustment unit is for receiving each video signal having more than one new frame rate and is outputted by the video separation unit, and for increasing or reducing each new frame rate of each video signal and outputting each video signal to each display device after the increasing or reducing operation.

7. The video signal receiving apparatus according to claim 6, wherein each video adjustment unit further adjusts each new frame rate into each original frame rate.

8. The video signal receiving apparatus according to claim 6, wherein the video signal receiving apparatus is respectively set in each display device, a switch, a splitter, a matrix, or an extender.

9. The video signal receiving apparatus according to claim 6, wherein each display device has different video interfaces.

10. The video signal receiving apparatus according to claim 6, wherein the video signal receiving apparatus further has an operation of processing video formats for outputting the video signals to each display device which has different video formats.

11. The video signal receiving apparatus according to claim 6, wherein the video signal receiving apparatus further makes each display device display the same frame or different frames at the same time.

12. A video signal transmission method which is applicable to at least two video signal sending apparatuses and at least one video signal receiving apparatus for signal transmission, the method comprising:
adjusting more than one original frame rate of video signals into more than one new frame rate by each video signal sending apparatus;
combining each video signal which has each new frame rate into an integrated video signal having each original frame rate by each video signal sending apparatus; and
sending the integrated video signal which has each original frame rate to a remote end through a sending channel by each video signal sending apparatus.

13. The video signal transmission method according to claim 12, wherein a sum of each new frame rate of each video signal is smaller than or equals to a maximum frame rate within a bandwidth range of the sending channel.

14. The video signal transmission method according to claim 12, wherein after the step of sending the integrated video signal which has each original frame rate to the remote end, further comprising:
receiving the integrated video signal which has each original frame rate by the video signal receiving apparatus;
separating the integrated video signal which has each original frame rate into each video signal which has each new frame rate by each video signal receiving apparatus; and
increasing or reducing each new frame rate of each video signal by each video signal receiving apparatus, and outputting each video signal to each display device.

15. The video signal transmission method according to claim 12, wherein each video signal receiving apparatus further has an operation of processing video formats for outputting the video signals to each display device having different video interfaces.

16. The video signal transmission method according to claim 12, wherein each video signal receiving apparatus further makes each display device display the same frame or different frames at the same time.
